(19) United States
(12) Patent Application Publication
(10) Pub. No.: US 2026/0121309 A1
(43) Pub. Date: Apr. 30, 2026

(54) TERMINAL BLOCK WITH ANTI-MISOPERATION STRUCTURE AND CONNECTING TERMINAL MODULE THEREOF

(71) Applicants: DINKLE ENTERPRISE CO., LTD., New Taipei City (TW); DINKLE ELECTRIC MACHINERY (CHINA) CO., LTD., Kunshan City (CN); LI YANG ELECTRIC MACHINERY (DONGGUAN) CO., LTD., Dong Guan City (CN)

(72) Inventor: Shang-Tsai WU, New Taipei City (TW)

(21) Appl. No.: 18/932,515

(22) Filed: Oct. 30, 2024

(51) Int. Cl. H01R 4/48; H01R 9/24

(52) U.S. Cl. CPC H01R 4/4816; H01R 4/48185; H01R 9/2416

(57) ABSTRACT

A terminal block with an anti-misoperation structure and its connecting terminal module are provided. An insulating base of the terminal block includes a cavity, two fixed blocks, and two wiring grooves. The connecting terminal module is positioned within the cavity. The connecting terminal module includes a fixed terminal, two pivotable terminals, and an anti-misoperation structure. The fixed terminal includes a horizontal plate and two upright plates. The pivotable terminal abuts against the fixed block and has a pivotable piece that blocks between the wiring groove and the cavity, along with a stop piece corresponding to the pivotable piece. The stop piece has a latch portion engaged with the pivotable piece. The anti-misoperation structure includes a resisting protrusion extending from the pivotable piece. When the pivotable piece is engaged with the latch portion, the resisting protrusion abuts against a side of the latch portion away from the stop piece.

### BACKGROUND OF THE DISCLOSURE

### Technical Field

The present disclosure relates to a terminal block structure, and more particularly, to a terminal block with an anti-misoperation structure and a connecting terminal module thereof.

### Description of Related Art

Terminal blocks are common connectors extensively used in fields such as industrial communications with high data volumes, tightly integrated industrial equipment, power industries enhancing system reliability and safety, and highly automated industrial control.

Conventionally, a terminal block structure includes a plastic housing with a connecting terminal module and a handle installed in the plastic housing. The plastic housing is equipped with an inlet for wire insertion. The connecting terminal module consists of an upper spring plate and a lower spring plate; the upper spring plate features a free end on one end and a latch on the other end. The free end may either block inside the inlet or rest against the lower spring plate. The handle facilitates the engagement of the free end with the latch, allowing the wire to be smoothly positioned between the upper and lower spring plates until the wire reaches the other end of the upper spring plate. This allows the free end to disengage from the latch and secure the wire together with the lower spring plate, thus establishing an electrical connection with both the upper and lower spring plates.

However, during the process of inserting a wire into the inlet, if the wire accidentally contacts the upper spring plate before reaching the other end, it may cause the upper spring plate to oscillate. This oscillation may lead to the detachment of the free end from the latch, resulting in a wire end failing to pass beyond the free end and becoming clamped between the free end and the lower spring plate. Consequently, the wire becomes prone to being pulled out from the terminal block structure, thereby reducing the stability of the connection between the connecting terminal module and the wire.

In light of this, the inventor of the present disclosure has dedicated effort to thoroughly study and apply theoretical principles to address the aforementioned issues, which has become the goal of the development of this disclosure.

### SUMMARY OF THE DISCLOSURE

The present disclosure provides a terminal block with an anti-misoperation structure and a connecting terminal module thereof, which utilizes a resisting protrusion to block at a side of the latch portion away from the stop piece, ensuring that wires or cables are unable to touch the latch portion. This arrangement ensures that the terminal block and the connecting terminal module offer enhanced misoperation prevention and stable connection.

According to one embodiment of the present disclosure, a terminal block with an anti-misoperation structure is provided, including: an insulating base with a cavity inside, two fixing blocks accommodated in the cavity, and two wiring grooves located on an external surface of the insulating base and communicating with the cavity; and a connecting terminal module accommodated in the cavity, the connecting terminal module including: a fixed terminal including a horizontal plate and two upright plates extending upward from two ends of the horizontal plate, wherein each fixing block and the horizontal plate are disposed on upper and lower sides of each wiring groove, respectively; two pivotable terminals abutting against the two fixing blocks, wherein one end of each pivotable terminal extends with a pivotable piece disposed outside a corresponding one of the upright plates and blocking between a corresponding one of the wiring grooves and the cavity, another end of each pivotable terminal extends with a stop piece corresponding to one of the pivotable pieces, and each of the stop pieces extends with a latch portion for engagement with a corresponding one of the pivotable pieces; and an anti-misoperation structure including a resisting protrusion extending from each of the pivotable pieces, wherein when the pivotable piece is engaged with the latch portion, the resisting protrusion abuts against one side of the latch portion away from the stop piece.

According to one embodiment of the present disclosure, a connecting terminal module with an anti-misoperation structure is provided, including: a pivotable terminal, wherein one end of the pivotable terminal extends with a pivotable piece, another end of the pivotable terminal extends with a stop piece disposed corresponding to the pivotable piece, and the stop piece extends with a latch portion for engagement with the pivotable piece; and an anti-misoperation structure including a resisting protrusion extending from the pivotable piece, wherein when the pivotable piece is engaged with the latch portion, the resisting protrusion abuts against one side of the latch portion away from the stop piece.

Based on the above, the present disclosure ensures that the resisting protrusion blocks at the side of the latch portion away from the stop piece, ensuring that wires or cables cannot touch the latch portion. This setup allows an end of a wire or a cable to pass beyond the pivotable piece, with a rear section of the wiring being clamped between the horizontal plate and the pivotable piece. Even when the wires or cables are slightly pulled or moved, the rear section to the end of the wiring remains securely clamped between the horizontal plate and the pivotable piece. This ensures that the terminal block and the connecting terminal module have the advantages of preventing misoperation and providing stable connections.

### BRIEF DESCRIPTION OF THE DRAWINGS

FIG. 1 is an exploded perspective view of a terminal block of the present disclosure.

FIG. 2 is a schematic perspective view of a pivotable terminal of the present disclosure.

FIG. 3 is an assembled perspective view of the terminal block of the present disclosure.

FIG. 4 is a cross-sectional assembly view of the terminal block of the present disclosure.

FIG. 5 is a schematic view of the terminal block in use according to the present disclosure.

FIG. 6 is a schematic view of another usage state of the terminal block of the present disclosure.

FIG. 7 is a schematic view of yet another usage state of the terminal block of the present disclosure.

FIG. 8 is a schematic view of still another usage state of the terminal block of the present disclosure.

FIG. 9 is an assembled perspective view of another embodiment of the pivotable terminal of the present disclosure.

FIG. 10 is an assembled perspective view of yet another embodiment of the pivotable terminal of the present disclosure.

### DETAILED DESCRIPTION

A detailed description and technical content of the present disclosure are provided below, accompanied by drawings. However, the drawings are provided only for explanatory purposes and are not intended to limit the scope of the present disclosure.

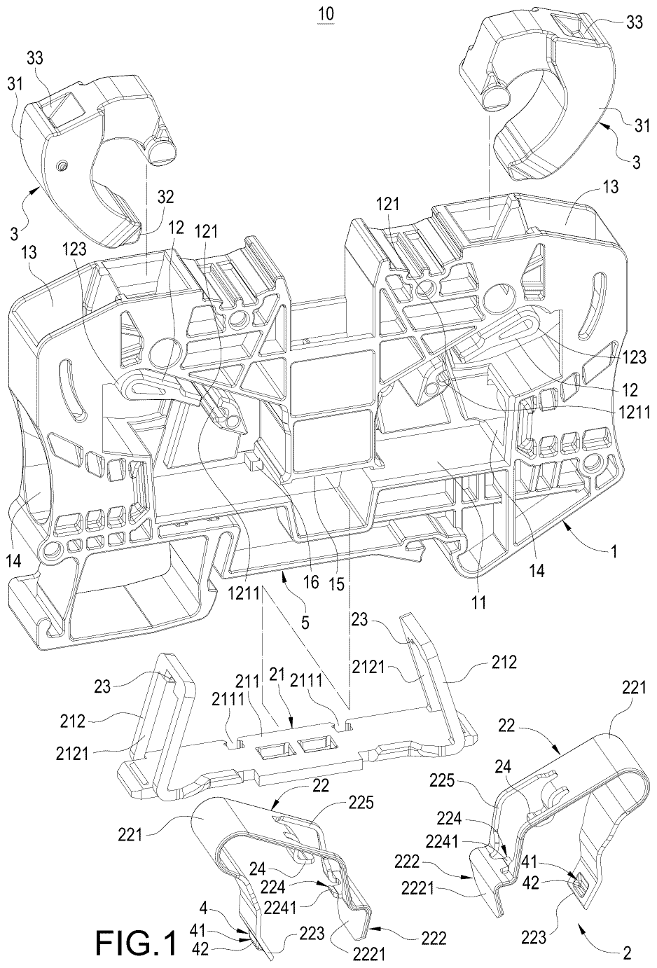

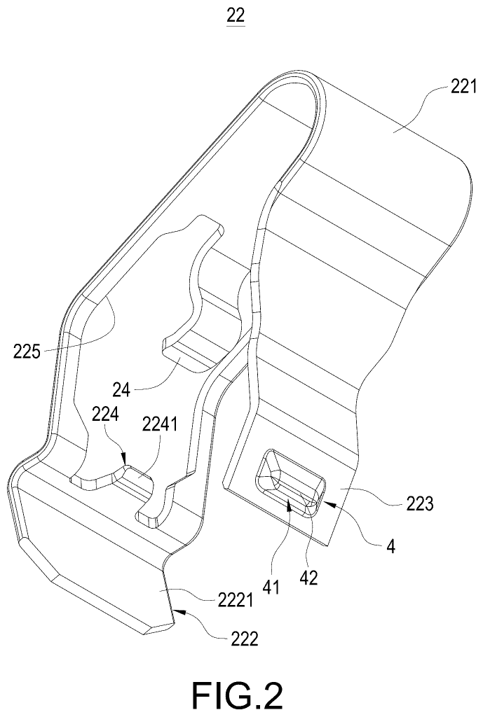

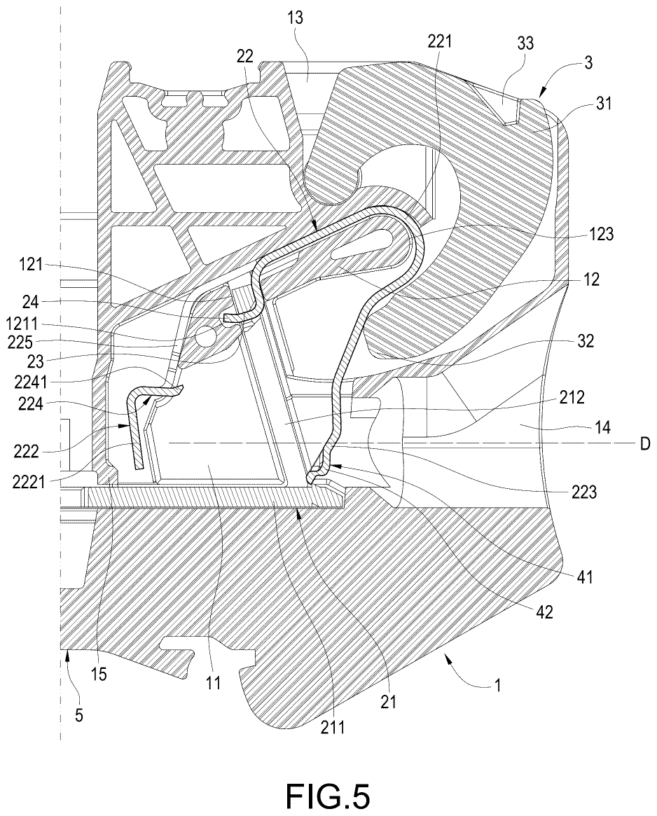

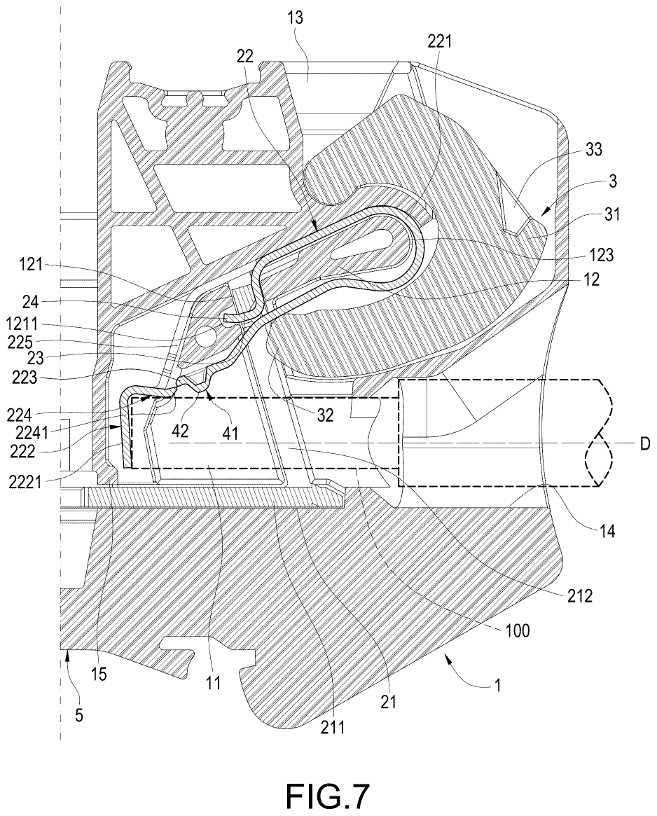

Refer to FIGS. 1 through 8, the present disclosure provides a terminal block with an anti-misoperation structure and a connecting terminal module thereof. The terminal block 10 primarily includes an insulating base 1 and a connecting terminal module 2. The connecting terminal module 2 primarily includes a pivotable terminal 22 and an anti-misoperation structure 4.

As shown in FIGS. 1, 3 to 8, the insulating base 1 is made of plastic and includes a cavity 11 inside, and two fixed blocks 12 accommodated inside the cavity 11. On an external surface of the insulating base 1, two communication slots 13 and two wiring grooves 14 communicate with the cavity 11. The communication slots 13 are located above the cavity 11, and a bottom of the insulating base 1 includes a track latch 5 for engagement with a track (not illustrated in figures).

The two wiring grooves 14 are arranged on the left and right sides of the insulating base 1, respectively, so that the two wiring grooves 14 are located on the left and right sides of the cavity 11. The two fixed blocks 12 are situated in the upper section of the cavity 11, while the two wiring grooves 14 communicate with the lower section of the cavity 11. In this embodiment, axes D of the two wiring grooves 14 extend along the same horizontal line, but this is not limiting, as the axes D of the two wiring grooves 14 may also intersect each other.

In detail, the two fixed blocks 12 are left-right symmetrical, with each fixed block 12 featuring a through-hole 121 on its top surface and a curved end 123 at one end. An inner wall of each through-hole 121 is provided with a recess 1211. The insulating base 1 further includes a downwardly protruding column 15 and a plurality of protrusions 16 within the cavity 11.

As shown in FIGS. 1 to 8, the terminal block module 2 is accommodated within the cavity 11. The terminal block module 2 includes a fixed terminal 21, two pivotable terminals 22, and an anti-misoperation structure 4. The fixed terminal 21 and the pivotable terminals 22 are made of conductive metal, and a thickness of the fixed terminal 21 is greater than a thickness of each pivotable terminal 22.

More specifically, the fixed terminal 21 includes a horizontal plate 211 that is disposed corresponding to a bottom edge of each wiring groove 14 and two upright plates 212 that extend upward from two ends of the horizontal plate 211. Each fixed block 12 and the horizontal plate 211 are disposed on upper and lower sides of the corresponding wiring groove 14, respectively. The axis D of each wiring groove 14 is parallel to the horizontal plate 211, but this is not limiting, as the axis D of each wiring groove 14 may also be inclined relative to the horizontal plate 211.

A middle section of the horizontal plate 211 is abutted by the downwardly protruding column 15. The horizontal plate 211 is provided with a plurality of notches 2111. Each protrusion 16 is engaged with a corresponding one of the notches 2111 to securely position the horizontal plate 211 within the cavity 11. Each upright plate 212 passes through the corresponding through-hole 121 so that the two upright plates 212 are inserted into the two fixed blocks 12.

In addition, each pivotable terminal 22 includes a U-shaped bent plate 221. The middle of each U-shaped bent plate 221 abuts against each arc-shaped end 123, so that the two pivotable terminals 22 stably abut against the two fixing blocks 12. One end of each pivotable terminal 22 extends with a pivotable piece 223 that is disposed outside one of the upright plates 212 and blocks between the corresponding wiring groove 14 and the cavity 11. The other end of each pivotable terminal 22 extends with a stop piece 222 that corresponds to one of the pivotable pieces 223. Each stop piece 222 and each pivotable piece 223 extend from two ends of one of the U-shaped bent plates 221. Each stop piece 222 extends with a latch portion 224 that may be engaged with one of the pivotable pieces 223.

Furthermore, each pivotable terminal 22 is provided with a through opening 225 located between the U-shaped bent plate 221 and the stop piece 222. Each latch portion 224 is a latch 2241 extending from a bottom end of an inner periphery of one of the through openings 225. An end of the pivotable piece 223 may be engaged with the latch 2241.

Moreover, each upright plate 212 is provided with an engagement slot 23. A latching plate 24 extends from an inner side of each U-shaped bent plate 221. Each latching plate 24 is engaged with each engagement slot 23, and an end of each latching plate 24 extends into each through-hole 121 and is engaged with each recess 1211. Each latching plate 24 extends from a top end of the inner periphery of each through opening 225.

Additionally, each upright plate 212 is provided with a hollow opening 2121 disposed corresponding to one of the wiring grooves 14. Each pivotable piece 223 may pass through one of the hollow openings 2121. Each engagement slot 23 is recessed from an inner periphery of one of the hollow openings 2121. An end of each stop piece 222 is bent to have an inverted L-shaped stop portion 2221. Each inverted L-shaped stop portion 2221 is used to stop an end of a wiring 100 such as a wire or a cable.

Furthermore, the horizontal plate 211 and each upright plate 212 are integrally formed in a U-shape, and each pivotable terminal 22 is shaped in an inverted V, allowing the fixed terminal 21 and the two pivotable terminals 22 to collectively form a butterfly-shaped frame.

As shown in FIGS. 1 to 8, the anti-misoperation structure 4 includes a resisting protrusion 41 extending from the pivotable piece 223. When the pivotable piece 223 is engaged with the latch portion 224, the resisting protrusion 41 blocks on the side of the latch portion 224 away from the stop piece 222. In this embodiment, the resisting protrusion 41 is a boss 42 formed by stamping on the pivotable piece 223, although this is not limiting.

As illustrated in FIGS. 1, and 3 to 8, the terminal block 10 further includes two inner push handles 3. Each of the two inner push handles 3 is accommodated within their respective communication slots 13. One end of each inner push handle 3 is pivotably connected to the insulating base 1 and the other end of each inner push handle 3 abuts against the pivotable piece 223.

Detailed description follows: Each inner push handle 3 is a U-shaped handle 31. One end of each inner push handle 3 is pivotably connected to the insulating base 1 and positioned above the U-shaped bent plate 221, while the other end of each inner push handle 3 features a movable end 32 that abuts against the pivotable piece 223. A pressing indentation 33, exposed from each communication slot 13, accommodates a flat tool such as a screwdriver (not shown in figures). By the flat tool inserted into the pressing indentation 33, the U-shaped handle 31 is driven to rotate, thus causing the movable end 32 to push the pivotable piece 223 towards the wiring groove 14.

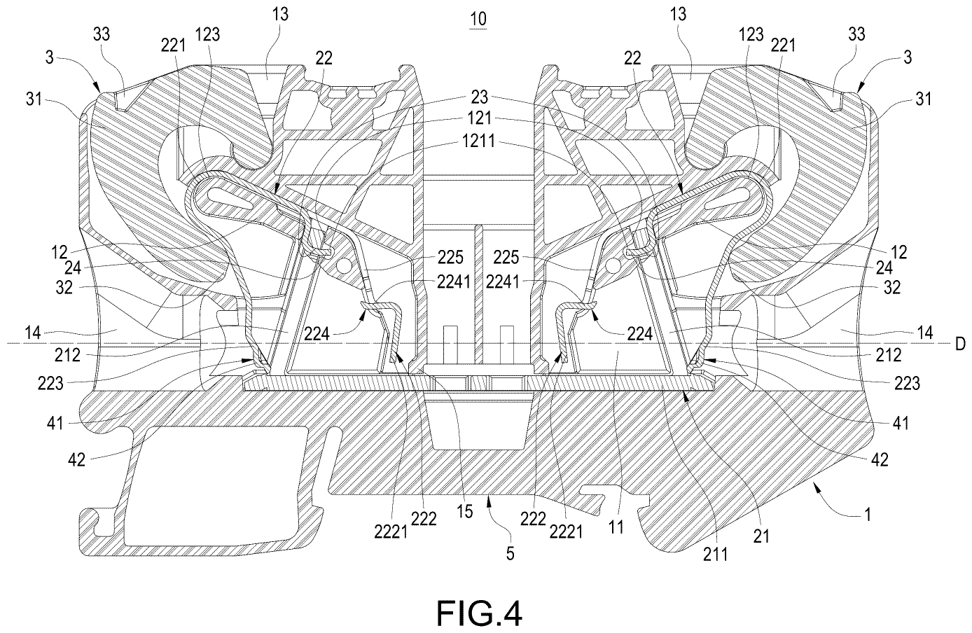

As shown in FIGS. 4 to 7, the usage state of the terminal block 10 involves inserting a flat tool such as a screwdriver into the pressing indentation 33, which may drive the inner push handle 3 to rotate. This action moves the movable end 32 to push against the pivotable piece 223 towards the wiring groove 14, until the pivotable piece 223 engages with the latch portion 224. This allows wires or cables, referred to as the wiring 100, to be smoothly inserted into the wiring groove 14 up to the point where they are blocked by the stop piece 222. The resisting protrusion 41 blocks by being positioned on one side of the latch portion 224 away from the stop piece 222, specifically on the side of the latch portion 224 adjacent to the wiring groove 14. This placement of the resisting protrusion 41 ensures that before the wiring 100 may impact the latch portion 224, it is blocked by the resisting protrusion 41, thus preventing direct contact with the latch portion 224. This avoids any unintentional disengagement of the pivotable piece 223 from the latch portion 224 due to the wiring impacting the latch portion 224, which may otherwise cause a loosening or release of the pivotable piece 223 from the latch portion 224. Ultimately, the wiring 100 hits the stop piece 222 and pushes it inward, releasing the pivotable piece 223 from the latch portion 224. The pivotable piece 223 then resets to a position blocking between the wiring groove 14 and the cavity 11, until the wiring 100 is clamped between the horizontal plate 211 and the pivotable piece 223, effectively being held between the fixed terminal 21 and the pivotable terminal 22, thus completing the wiring operation of the terminal block 10.

In related art, it is known that when the wiring 100, such as a wire or a cable, impacts the latch portion 224, it may cause the pivotable piece 223 to disengage from the latch portion 224. This leads to the wiring 100, such as a wire or a cable, being clamped between the horizontal plate 211 and the pivotable piece 223 without its end fully passing beyond the pivotable piece 223. When the wiring 100 is slightly pulled or moved afterward, the end of the wiring 100 may slip out from between the horizontal plate 211 and the pivotable piece 223. In contrast, in the present disclosure, the resisting protrusion 41 is positioned on the side of the latch portion 224 away from the stop piece 222, ensuring that the wiring 100 cannot make contact with the latch portion 224. This allows the end of the wiring 100 to fully pass beyond the pivotable piece 223, ensuring that a rear section of the wiring 100 is clamped between the horizontal plate 211 and the pivotable piece 223. Even when the wiring 100 is slightly pulled or moved afterward, the rear section to the end of the wiring 100 remains securely clamped between the horizontal plate 211 and the pivotable piece 223. This enhances the stability of the connection between the connecting terminal module 2 and the wiring 100, providing the terminal block 10 and the connecting terminal module 2 with the advantages of misoperation prevention and stable wiring.

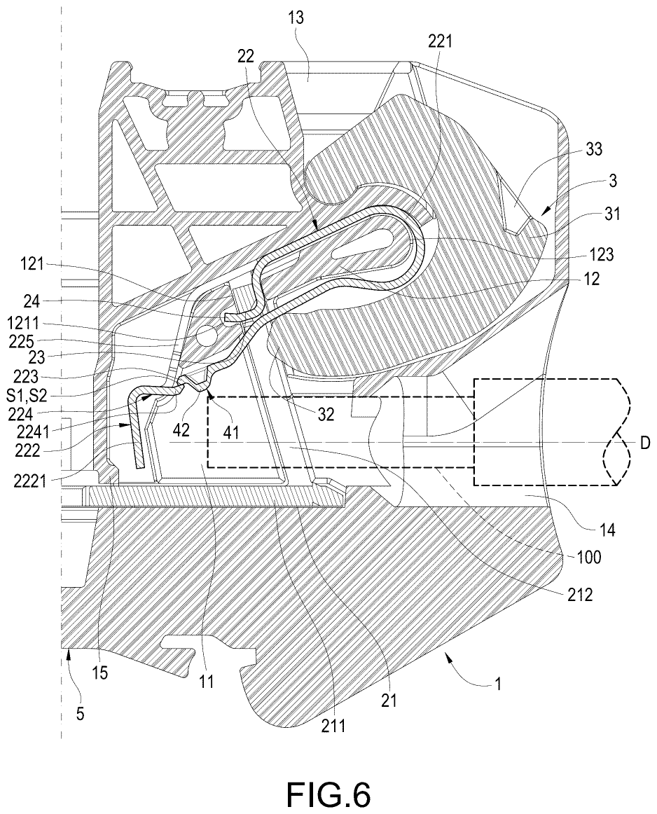

Additionally, as shown in FIG. 6, when the end of each pivotable piece 223 is engaged with each latch 2241, the end of each pivotable piece 223 features a first surface S1 that contacts one of the latches 2241, and each latch 2241 features a second surface S2 that contacts the end of one of the pivotable pieces 223. Both the first surface S1 and the second surface S2 are on the same plane, which facilitates easier locking and unlocking of the pivotable piece 223 with the latch 2241 and allows for greater tolerances. This design simplifies the control of engaging and disengaging the end of the pivotable piece 223 with the latch 2241.

Furthermore, the bottom of the insulating base 1 of this disclosure may be engaged on a track through the track latch 5, thereby positioning the horizontal plate 211 to lie parallel to a horizontal plane. In this embodiment, the axis D of each wiring groove 14 is also set parallel to the horizontal plate 211, and thus, parallel to the horizontal plane as well. When the wiring 100, such as wires or cables, is inserted into the wiring groove 14, exposed parts of the wiring 100 outside the terminal block 10 naturally lay flat in alignment with the horizontal plane. This arrangement eliminates the need for manual bending of the wiring, as is necessary in related art, thereby achieving the advantages of naturally flat alignment of the wiring 100 upon insertion and enhancing ease of use. However, it is not limited to this configuration; the axis D of each wiring groove 14 may also be set at an angle to the horizontal plane.

Furthermore, in related art, an inlet for wiring is typically set at an angle to the horizontal plane. In this embodiment, the axis D of each wiring groove 14 is set parallel to the horizontal plane, and the inner push handle 3 is configured to be rotatable and positioned above the pivotable terminal 22 near the pivotable piece 223, reducing the force required for operation compared to related art. This configuration enables the inner push handle 3 to smoothly push open the pivotable piece 223, thereby providing the terminal block 10 with the advantage of effortless insertion.

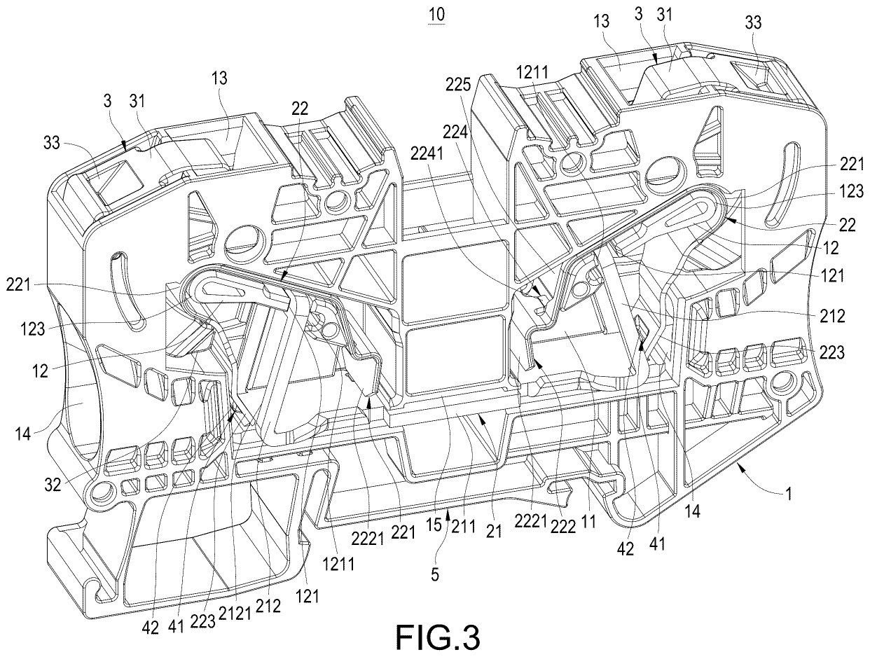

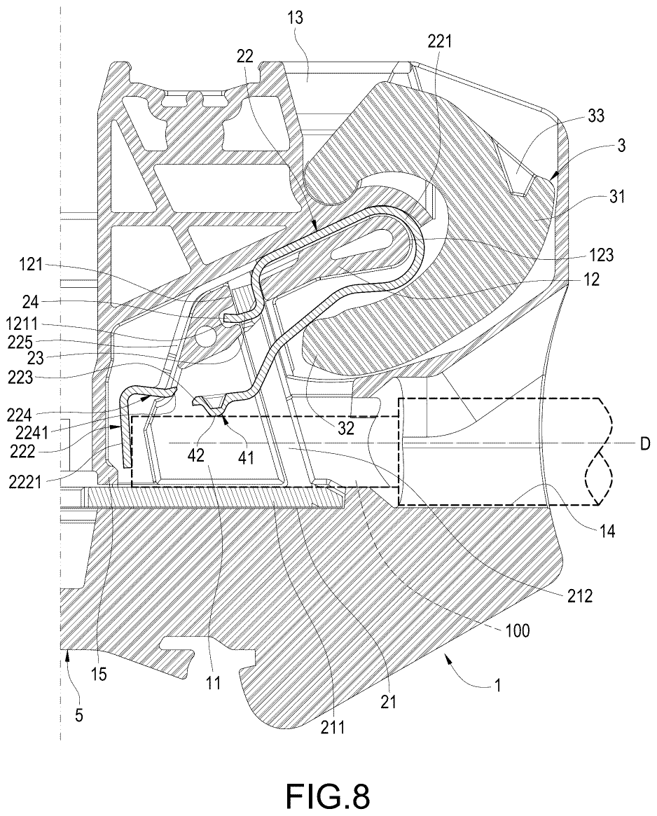

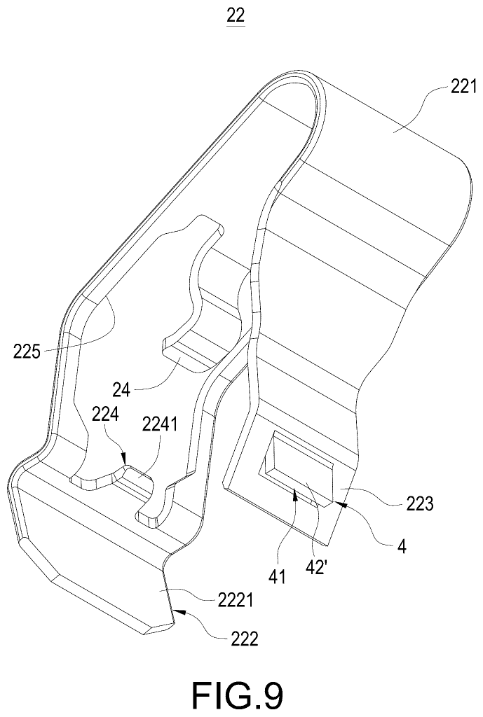

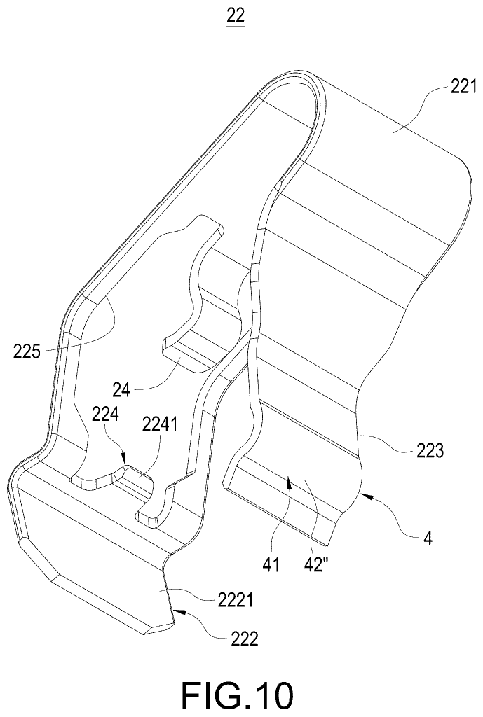

Refer to FIGS. 9 and 10, which show another embodiment and yet another embodiment of the pivotable terminal 22 of this disclosure. The embodiments in FIGS. 9 and 10 are generally similar to those in FIGS. 1 to 8. The difference between the embodiments in FIGS. 8 and 9 compared to FIG. 3 lies in the different forming methods of the resisting protrusion 41. As shown in FIG. 9, the resisting protrusion 41 is formed by first cutting and then stamping a boss 42′ on the pivotable piece 223; as shown in FIG. 10, the resisting protrusion 41 is formed by bending a boss 42″ on the pivotable piece 223. Accordingly, the bosses 42′ in FIGS. 9 and 42″ in FIG. 10 achieve the same functions and effects as the boss 42 in FIGS. 1 to 8.

What is claimed is:

1. A terminal block, comprising:
an insulating base, comprising a cavity defined inside, two fixing blocks accommodated in the cavity, and two wiring grooves defined outside and communicating with the cavity; and
a connecting terminal module, accommodated in the cavity, and comprising:
a fixed terminal, comprising a horizontal plate and two upright plates extending upward from two ends of the horizontal plate, wherein each fixing block and the horizontal plate are disposed on upper side and lower side of each wiring groove, respectively;
two pivotable terminals, abutting against the two fixing blocks, wherein each pivotable terminal comprises a pivotable piece extending from one end thereof and disposed outside one of the upright plates and blocking between one of the wiring grooves and the cavity, each pivotable terminal further comprises a stop piece extending from another end thereof corresponding to the pivotable piece, and the stop piece comprises a latch portion engaged with the pivotable piece; and
an anti-misoperation structure, comprising a resisting protrusion extending from the pivotable piece, wherein when the pivotable piece is engaged with the latch portion, the resisting protrusion abuts against one side of the latch portion away from the stop piece.

2. The terminal block according to claim 1, wherein the resisting protrusion is a boss stamped on the pivotable piece.

3. The terminal block according to claim 1, wherein the resisting protrusion is a boss cut and stamped on the pivotable piece.

4. The terminal block according to claim 1, wherein the resisting protrusion is a boss bent from the pivotable piece.

5. The terminal block according to claim 1, wherein each of the fixing blocks comprises a through hole defined on a top surface and a curved end disposed on one end, each of the upright plates is inserted through the through hole, each of the pivotable terminals comprises a U-shaped bent plate, a middle portion of each U-shaped bent plate abuts against the curved end, and the stop piece and the pivotable piece extend from two ends of each U-shaped bent plate.

6. The terminal block according to claim 5, wherein each of the pivotable terminals comprises a through opening located between the U-shaped bent plate and the stop piece, the latch portion is a latch extending from a bottom end of an inner periphery of the through opening, and an end of the pivotable piece is engaged with the latch.

7. The terminal block according to claim 6, wherein when the end of the pivotable piece is engaged with the latch, the end of the pivotable piece comprises a first surface contacting the latch, the latch comprises a second surface contacting the end of the pivotable piece, and both the first surface and the second surface are on a same plane.

8. The terminal block according to claim 6, wherein each of the upright plates comprises an engagement slot, an inner side of each of the U-shaped bent plates extends with a latching plate, the latching plate is engaged with the engagement slot, and the latching plate extends from a top end of an inner periphery of the through opening.

9. The terminal block according to claim 8, wherein the through-hole comprises a recess located on an inner wall thereof, an end of the latching plate extends into the through-hole and is engaged with the recess.

10. The terminal block according to claim 8, wherein each upright plate comprises a hollow opening arranged corresponding to one of the wiring grooves, each of the pivotable pieces is inserted in the hollow opening, each of the engagement slots is recessed from a top end of an inner periphery of each through opening, and an end of the stop piece is bent into an inverted L-shaped stop portion.

11. The terminal block according to claim 5, further comprising two inner push handles, wherein the insulating base further comprises two communication slots communicating with the cavity and located outside, each of the inner push handles is accommodated in one of the communication slots, one end of each inner push handle is pivotably connected to the insulating base, and another end of each inner push handle abuts against one of the pivotable pieces, wherein each of the inner push handles is a U-shaped handle, one end of each U-shaped handle is pivotably connected to the insulating base and disposed above each U-shaped bent plate, another end of each inner push handle is provided with a movable end abutting against one of the pivotable pieces, and a pressing indentation is located in a middle portion of each inner push handle and exposed from one of the communication slots.

12. A connecting terminal module, comprising:
a pivotable terminal, wherein one end of the pivotable terminal extends with a pivotable piece, another end of the pivotable terminal extends with a stop piece disposed corresponding to the pivotable piece, and the stop piece extends with a latch portion engaged with the pivotable piece; and
an anti-misoperation structure, comprising a resisting protrusion extending from the pivotable piece, wherein when the pivotable piece is engaged with the latch portion, the resisting protrusion abuts against one side of the latch portion away from the stop piece.

13. The connecting terminal module according to claim 12, wherein the resisting protrusion is a boss stamped on the pivotable piece.

14. The connecting terminal module according to claim 12, wherein the resisting protrusion is a boss cut and stamped on the pivotable piece.

15. The connecting terminal module according to claim 12, wherein the resisting protrusion is a boss bent from the pivotable piece.

16. The connecting terminal module according to claim 12, wherein the pivotable terminal comprises a U-shaped bent plate, the stop piece and the pivotable piece extend from two ends of the U-shaped bent plate, the pivotable terminal is provided with a through opening located between the U-shaped bent plate and the stop piece, the latch portion is a latch extending from a bottom end of an inner periphery of the through opening, and an end of the pivotable piece is engaged with the latch.

17. The connecting terminal module according to claim 16, wherein when the end of each pivotable piece is engaged with the latch, the end of the pivotable piece comprises a first surface contacting the latch, the latch comprises a second surface contacting the end of the pivotable piece, and both the first surface and the second surface are on a same plane.
